(19) United States
(12) Patent Application Publication
(10) Pub. No.: US 2006/0138175 A1
(43) Pub. Date: Jun. 29, 2006

(54) Product dispenser actuation device

(76) Inventor: Frank A. Germain JR., Chicopee, MA (US)

Correspondence Address: THE LAW OFFICES OF STEVEN MCHUGH, LLC, 46 WASHINGTON STREET, MIDDLETOWN, CT, 06457, US

(21) Appl. No.: 11/208,060

(22) Filed: Aug. 19, 2005

Related U.S. Application Data
(60) Provisional application No. 60/603,386, filed on Aug. 20, 2004.

(51) Int. Cl. B67D 5/06

(52) U.S. Cl. 222/321.8; 222/182

(57) ABSTRACT

A product dispenser and a method for implementing the product dispenser is provided, wherein the product dispenser includes a dispenser structure having a first dispenser portion and a second dispenser portion, wherein the first dispenser portion and the second dispenser portion define a dispenser cavity for containing a product container having an actuatable dispenser nozzle. The product dispenser also includes an actuation handle having a handle interface portion, wherein the actuation handle is movably associated with at least one of the first dispenser portion and the second dispenser portion to be configurable between a first configuration and a second configuration, wherein when the actuation handle is disposed in the first configuration the handle interface portion is actuatably associated with the dispenser nozzle.

### RELATED APPLICATIONS

This application claims priority of U.S. Provisional Patent Application Ser. No. 60/603,386 filed Aug. 20, 2004, the contents of which are incorporated herein by reference in its entirety.

### FIELD OF THE INVENTION

This disclosure relates generally to product dispensers and more particularly to a product dispenser actuation device for facilitating the dispensing of a product contained within a product container.

### BACKGROUND OF THE INVENTION

In the consumer food industry many products that are sold to restaurants are sold as individual components that must be mixed or added with other components to produce a desired end product. For example, in gourmet coffee shops many different types of flavored coffees are achievable simply by adding a desired flavoring. These flavorings are typically provided in syrup or liquid form and are contained in a product container having a dispensing device. Such a product container can be seen by referring to FIG. 1, where a typical product container 100 is shown, in accordance with the prior art. Product container 100 includes a product containment structure 102 defining a product cavity 104 for containing a liquid product 106 and a cavity opening 108 communicated with the product cavity 104. A dispensing device 110 is also provided and includes a dispensing device anchor mechanism 112, a dispensing nozzle 114 defining a nozzle cavity 116 and a product straw 118 defining a straw cavity 120, wherein the product straw 118 is associated with the dispensing nozzle 114 to communicate the straw cavity 120 with the nozzle cavity 116. As shown in FIG. 2, dispensing device 112 operates by applying pressure to the dispensing nozzle 114, wherein the application of pressure to the dispensing nozzle 114 causes the liquid product 106 contained within the product cavity 104 to travel into and through the straw cavity 120 and out of the nozzle cavity 116.

Although this type of dispensing device is effective at dispensing a liquid product and is relatively inexpensive to implement, the action of applying pressure to the dispensing nozzle 114 can create injuries to the hand, wrist, arm and/or shoulders of the person applying the pressure to the dispensing device 110. This is especially true with people whose job requires them to repeatedly use the dispensing device 110. As such, in order to avoid on the job injuries, workman compensation claims and/or lost time due to injury and/or illness, it would desirable to provide a device which can reduce the risk of injury caused by repeated compression of the dispensing nozzle 114 and that may be used with existing product dispensing technology.

### SUMMARY OF THE INVENTION

A product dispenser is provided, wherein the product dispenser includes a dispenser structure having a first dispenser portion and a second dispenser portion, wherein the first dispenser portion and the second dispenser portion define a dispenser cavity for containing a product container having an actuatable dispenser nozzle. The product dispenser also includes an actuation handle having a handle interface portion, wherein the actuation handle is movably associated with at least one of the first dispenser portion and the second dispenser portion to be configurable between a first configuration and a second configuration, wherein when the actuation handle is disposed in the first configuration the handle interface portion is actuatably associated with the dispenser nozzle.

A product dispenser is provided, wherein the product dispenser includes a dispenser structure having a dispenser base portion supporting a product container having an actuatable dispenser nozzle and an actuation handle having a handle interface portion, wherein the actuation handle is movably associated with the dispenser base portion to be configurable between a first configuration and a second configuration, wherein when the actuation handle is disposed in the first configuration the handle interface portion is actuatably associated with the dispenser nozzle.

A method for implementing a product dispenser is provided, wherein the product dispenser includes a dispenser base portion for supporting a product container having an actuatable dispenser nozzle and an actuation handle having a handle interface portion movably configurable between a first configuration and a second configuration. The method includes associating the product container with the dispenser base portion and configuring the actuation handle from the second configuration into the first configuration to be actuatably associated with the dispenser nozzle and reconfiguring the actuation handle from the first configuration into the second configuration.

### BRIEF DESCRIPTION OF DRAWINGS

The foregoing and other features and advantages of the present invention will be more fully understood from the following detailed description of illustrative embodiments, taken in conjunction with the accompanying drawings in which:

FIG. 1 is a side view of a product dispenser with the dispenser nozzle in the uncompressed configuration, in accordance with the prior art;

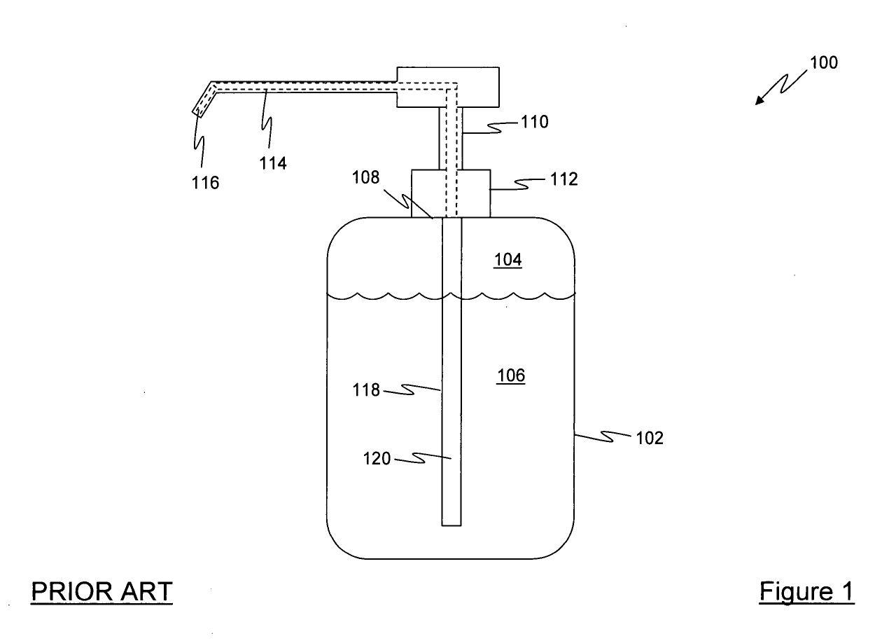

FIG. 2 is a side view of the product dispenser of FIG. 1 with the dispenser nozzle in the compressed configuration, in accordance with the prior art;

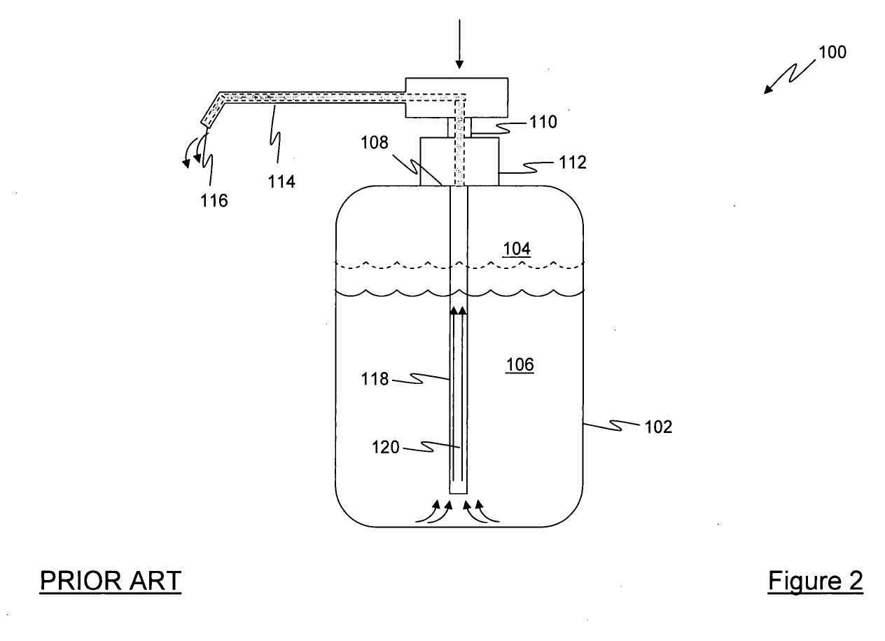

FIG. 3 is a front view of an actuation device in its non-actuating configuration, in accordance with an exemplary embodiment;

FIG. 4 is a side view of the actuation device of FIG. 3 in its non-actuating configuration;

FIG. 5 is a side view of the actuation device of FIG. 3 being configured between the actuating configuration and the non-actuating configuration.

FIG. 6 is a side view of the actuation device of FIG. 3 being used with the product dispenser of FIG. 1 with the actuation device in its non-actuating configuration;

FIG. 7 is a side view of the actuation device of FIG. 3 being used with the product dispenser of FIG. 1 with the actuation device in its actuating configuration; and

FIG. 8 is a block diagram illustrating a method for implementing the product dispenser of FIG. 1.

### DETAILED DESCRIPTION OF THE INVENTION

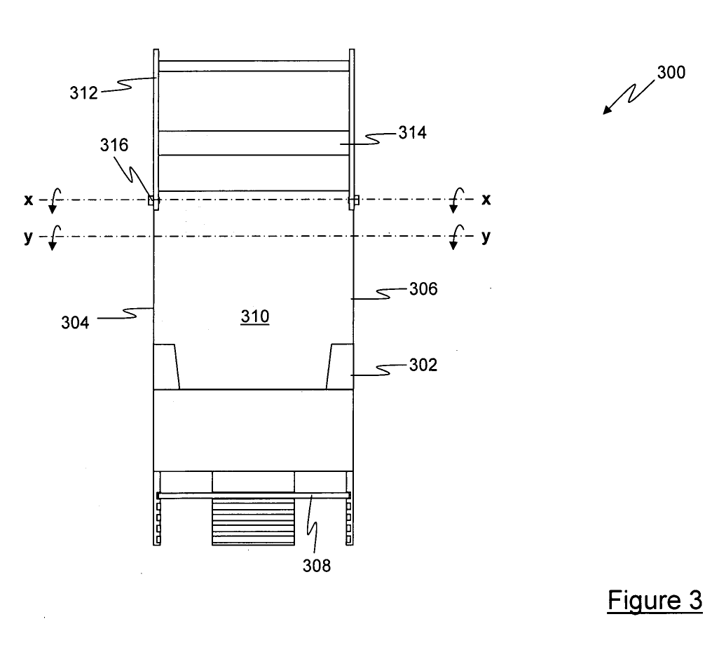

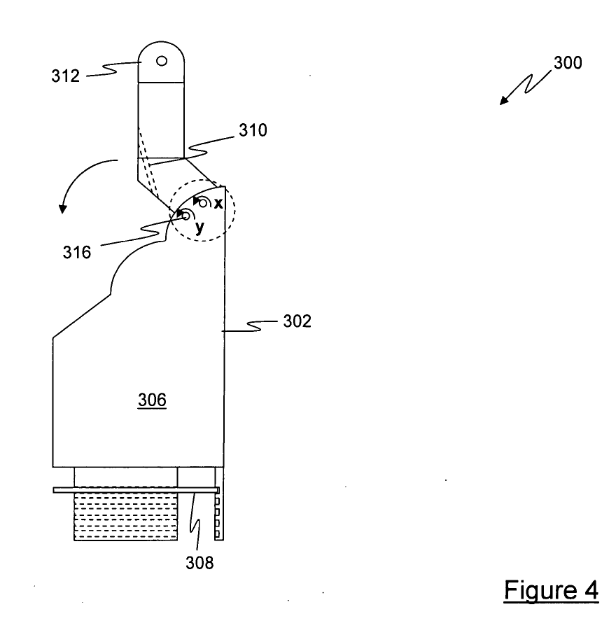

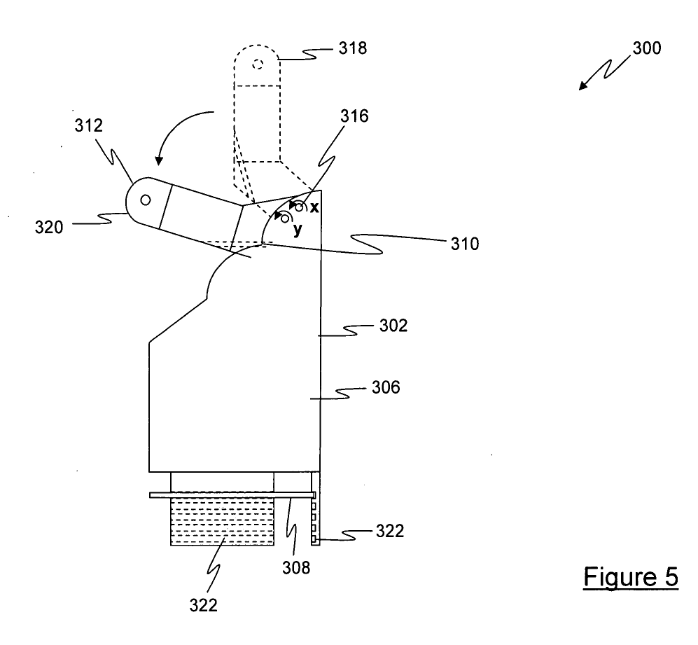

Referring to FIG. 3 and FIG. 4, a product dispenser actuation device 300 is shown and includes a device structure 302 having a first device side portion 304, a second device side portion 306 and a device base portion 308, wherein the first device side portion 304, the second device side portion 306 and the device base portion 308 defines a device cavity 310 for containing the product container 100, wherein the product container 100 includes a product dispenser 110 for dispensing the product 106 disposed within the product container cavity 104. The product dispenser actuation device 300 further includes an actuation handle 312 having an actuator 314, wherein the actuation handle 312 is movably associated with the actuation device 300 via a handle connection device 316 to allow the actuation handle 312 to controllably rotate about at least one axis. For example, as shown in FIG. 5, the actuation handle 312 is configurable between a non-actuating configuration 318 and an actuating configuration 320 by rotating about an axis x. Moreover, the handle connection device 316 and thus, the actuation handle 312, is configurable to operate about an axis y by adjusting the handle connection device 316.

The device structure 302 also includes a plurality of adjustment notches 322 disposed adjacent a bottom portion of the device structure 302 to allow the device base portion 308 to be configurable between a plurality of positions to accommodate product containers 100 of different sizes. As such, the ability to configure the actuation handle 312 to rotate about a plurality of axes x, y and/or the ability to adjust the size of the device cavity 310 allows product containers 100 of varying heights and/or having different types and/or sizes of dispensing nozzles 114 to be operatively disposed within the device cavity 310 and implemented via the actuation handle 312. It should be appreciated that the first device side portion 304 and/or the second device side portion 306 may also be configurable to accommodate product containers 100 of varying widths.

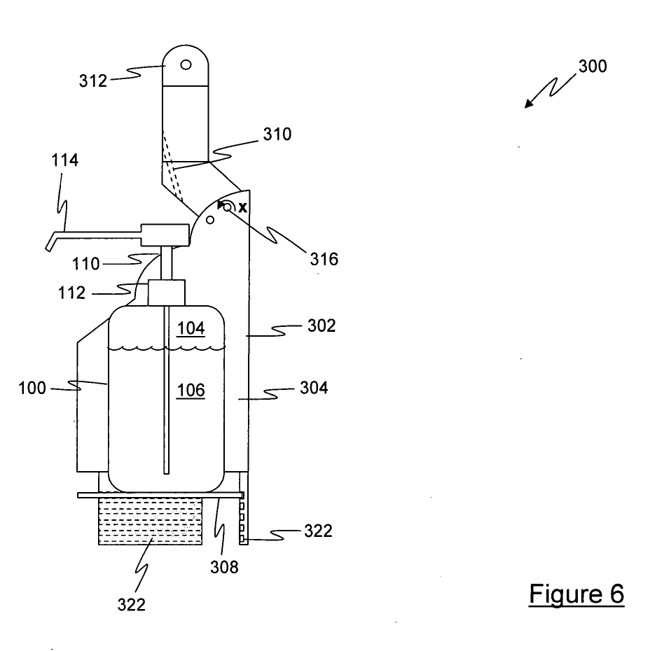

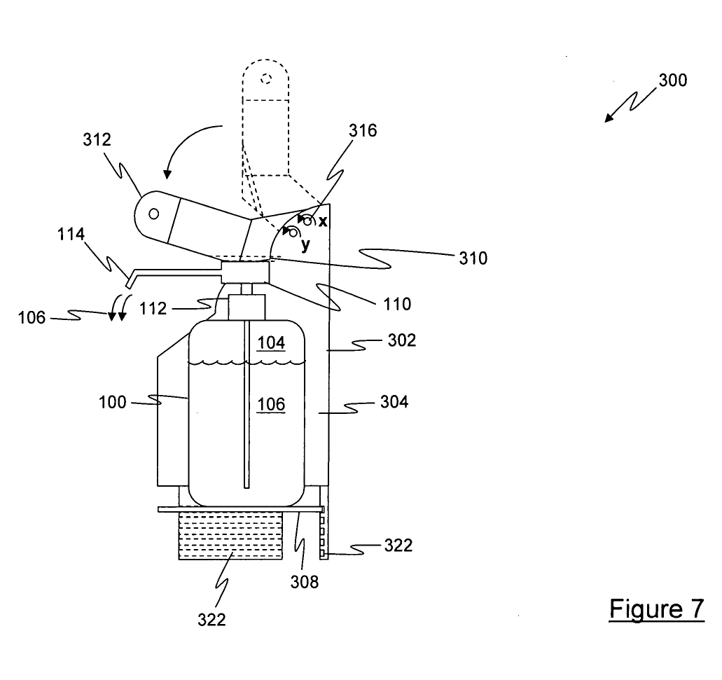

Referring to FIG. 6 and FIG. 7, the actuation device 300 operates as follows. In accordance with an exemplary embodiment, with the actuation handle 312 disposed in the non-actuating configuration 318 a product container 100 is disposed within the device cavity 310 such that the dispensing nozzle 114 is protruding from the front portion of the actuation device 300. The device base portion 308 may be adjusted in height via the adjustment notches 316 and the actuation handle 308 may be adjusted to rotate about either axis x or axis y to accommodate the size of the product container 100 and/or the size and/or type of the dispensing nozzle 114. When the product container 100 has been positioned as desired, the actuation handle 312 is configured to be in the actuating configuration 320 by moving the actuation handle 312 in the direction of the dispensing nozzle 114 to cause the actuation handle 312 to rotate about the chosen axis x, y. This causes the actuator 314 to contact the top portion of the dispenser nozzle 114 and apply a compression force to the dispenser nozzle 114 such that the dispenser nozzle 114 is compressed toward the product containment structure 102. During this compression, the product contained within the product cavity 104 is dispensed out of dispensing nozzle 114. The actuation handle 308 is then raised, either manually and/or automatically, to the non-actuating configuration 318 and the process is repeated responsive to the amount of product to be dispensed.

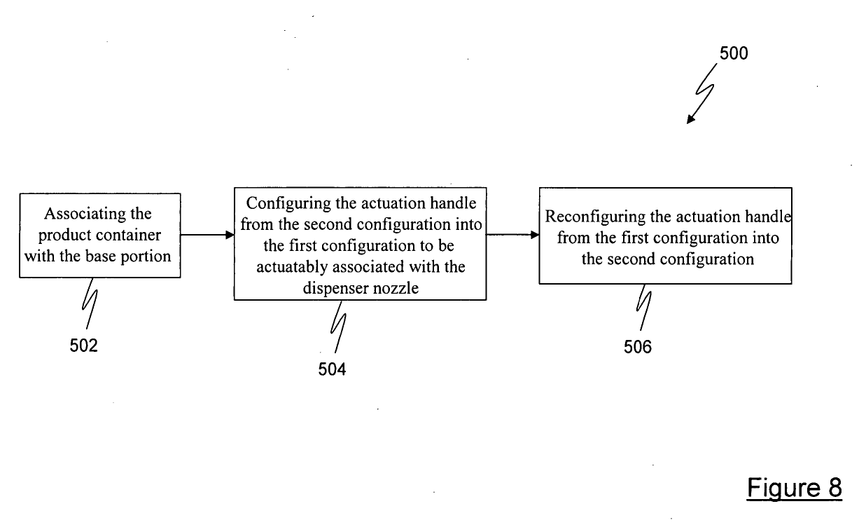

Referring to FIG. 8, a method 500 for implementing a product dispenser 300, is shown and includes associating the product container 100 with the dispenser base portion 308, as shown in operational block 502 and configuring the actuation handle 312 from the first configuration 318 into the second configuration 320 to be actuatably associated with the dispenser nozzle 114, as shown in operational block 504. The method 500 further includes reconfiguring the actuation handle 312 from the second configuration 320 into the first configuration 318, as shown in operational block 506.

It should be appreciated that the product dispenser actuation device 300 as disclosed herein may be used to dispense any product suitable to the desired end purpose, such as flavorings for drinks and toppings for ice cream. It should further be appreciated that actuation device 300 may be constructed of any material and/or combination of materials suitable to the desired end purpose, such as a Delrin, plastic, and/or a Polypropylene material.

While the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

We claim:

1. A product dispenser, comprising:
a dispenser structure having a first dispenser portion and a second dispenser portion, wherein said first dispenser portion and said second dispenser portion define a dispenser cavity for containing a product container having an actuatable dispenser nozzle; and
an actuation handle having a handle interface portion, wherein said actuation handle is movably associated with at least one of said first dispenser portion and said second dispenser portion to be configurable between a first configuration and a second configuration, wherein when said actuation handle is disposed in said first configuration said handle interface portion is actuatably associated with said dispenser nozzle.

2. A product dispenser according to claim 1, wherein when said actuation handle is disposed in said second configuration, said handle interface portion is actuatably disassociated from said dispenser nozzle.

3. A product dispenser according to claim 1, wherein when said actuation handle is disposed in said first configuration said actuation handle is compressible and actuatably associated with said dispenser nozzle.

4. A product dispenser according to claim 1, wherein said actuation handle is positionably configurable such that when said actuation handle is configured between said first configuration and said second configuration, said actuation handle rotates about at least one predefined axis.

5. A product dispenser according to claim 1, wherein said actuation handle is positionably configurable such that when said actuation handle is configured between said first configuration and said second configuration, said actuation handle rotates about at least one of a first predefined axis and a second predefined axis.

6. A product dispenser according to claim 1, wherein the product dispenser is at least partially constructed from at least one of a plastic material, a metal material, polypropylene, Delrin and any combination thereof.

7. A product dispenser according to claim 1, wherein said dispenser nozzle is compressibly actuatable.

8. A product dispenser, comprising:
a dispenser structure having a dispenser base portion supporting a product container having an actuatable dispenser nozzle; and
an actuation handle having a handle interface portion, wherein said actuation handle is movably associated with said dispenser base portion to be configurable between a first configuration and a second configuration, wherein when said actuation handle is disposed in said first configuration said handle interface portion is actuatably associated with said dispenser nozzle.

9. A product dispenser according to claim 8, wherein when said actuation handle is disposed in said second configuration, said handle interface portion is actuatably disassociated from said dispenser nozzle.

10. A product dispenser according to claim 8, wherein when said actuation handle is disposed in said first configuration said actuation handle is compressible and actuatably associated with said dispenser nozzle.

11. A product dispenser according to claim 8, wherein said actuation handle is positionably configurable such that when said actuation handle is configured between said first configuration and said second configuration, said actuation handle rotates about at least one predefined axis.

12. A product dispenser according to claim 8, wherein said actuation handle is positionably configurable such that when said actuation handle is configured between said first configuration and said second configuration, said actuation handle rotates about at least one of a first predefined axis and a second predefined axis.

13. A product dispenser according to claim 8, wherein the product dispenser is at least partially constructed from at least one of a plastic material, a metal material, polypropylene, Delrin and any combination thereof.

14. A product dispenser according to claim 8, wherein said dispenser nozzle is compressibly actuatable.

15. A method for implementing a product dispenser, wherein the product dispenser includes a dispenser base portion for supporting a product container having an actuatable dispenser nozzle and an actuation handle having a handle interface portion movably configurable between a first configuration and a second configuration, the method comprising:
associating the product container with the dispenser base portion; and
configuring the actuation handle from the second configuration into the first configuration to be actuatably associated with the dispenser nozzle; and
reconfiguring the actuation handle from the first configuration into the second configuration.
